(19) United States
(12) Patent Application Publication
(10) Pub. No.: US 2022/0148004 A1
(43) Pub. Date: May 12, 2022

(54) SYSTEMS AND METHODS FOR PREDICTING ON-FILE PAYMENT CREDENTIALS

(71) Applicant: First Performance Corp, Atlanta, GA (US)

(72) Inventor: Sosh A. Howell, Atlanta, GA (US)

(21) Appl. No.: 17/522,398

(22) Filed: Nov. 9, 2021

Related U.S. Application Data
(60) Provisional application No. 63/111,377, filed on Nov. 9, 2020.

(51) Int. Cl. G06Q 20/40; G06Q 20/38; G06Q 20/06

(52) U.S. Cl. CPC G06Q 20/4097; G06Q 20/4014; G06Q 20/065; G06Q 20/3821; G06Q 20/405

(57) ABSTRACT

Disclosed herein are systems and methods for predicting on-file payment credentials. The methods can include obtaining, from a financial institution, transaction data comprising one or more transactions conducted at one or more merchants. For each respective merchant of the one or more merchants, the methods can include parsing each of the one or more transactions at the respective merchant to create a merchant profile for the respective merchant, the merchant profile comprising merchant behavior data for the respective merchant. The methods can determine a likelihood of a respective associated merchant having the payment credential information on file by calculating a score for the merchant based on the merchant profile. The score can represent that the merchant profile is indicative of the associated merchant having the payment credential information stored on file.

### BACKGROUND

When consumers purchase goods and services from merchants through digital channels such as websites and mobile apps, they often have an account with that merchant. Merchants can choose to store the consumer's credit card, debit card, or other payment credential with the merchant to make future purchases easier or in some cases to automatically pay for a recurring service.

During the lifetime of a payment credential a user may lose track of what merchants have stored their payment credential on file. This can complicate a variety of tasks that the consumer may want to execute, such as reviewing where their payment credential is stored in cases that they wish would use this list to, for example, understand their ongoing spend or create a monthly budget.

In the case of a lost or stolen card, merchants can be identified that will need to receive a new card number that would not be updated through card network services such as MasterCard's Automatic Billing Updater. Lack of updating the card number could lead to disruption of service from the merchant, loss of revenue to the merchant, loss of revenue to the payment credential issuing bank as well as any institution that profits from the financial transaction between the consumer and merchant.

### BRIEF SUMMARY

The system of the present disclosure may be configured to analyze financial transactions of the payment credential and separately of the merchant to determine if a merchant has stored a consumer's payment credential.

As there is no way to guarantee the knowledge of whether a card is on file or not, a confidence score can be generated through the analysis of merchant behavior and payment behavior of the payment credential with the merchant. A score threshold can be set that determines if a merchant is presented to an end user as being a credential of file merchant.

Financial transactions may contain multiple data elements that may be analyzed to help identify if a merchant has a credential stored on file. This includes, but is not limited to the date, time, amount, merchant category code, usage of card verification value (CVV/CVV2) or similar field, and PAN entry mode.

In addition to data elements, derived factors from modifying or combining data elements or other analysis of the purchases or merchants can also be used to determine the likelihood score that a merchant is storing a credential on file, hereafter referred to as credential on file score.

Before analyzing a consumer's spending history with a merchant to determine credential on file, a merchant profile can be created to determine how the merchant uses data elements when consumers make purchases for the first time using the payment credential and when they make subsequent purchases with the same payment credential. Purchases can be identified as either a single financial transaction of $0 or more or groups on financial transactions. Purchase behavior can also be profiled between purchases where the consumer has an account and when they do not have an account with the merchant and may be combined with the behavior of the first purchase with a payment credential compared to subsequent purchases with a payment credential.

Purchases between a merchant and a consumer using a unique payment credential can be analyzed and optionally combined with the behavior profile of the merchant to determine if the credential is on file.

As an example, a consumer may make a first-time purchase with a merchant, in which case CVV may be present. They may return to the merchant, use the same account with a card stored on file in which case CVV might not be present. By seeing these two examples of a purchase from a payment credential to a merchant we can increase the confidence score that a merchant has a payment credential stored on file.

However, some merchants may request that CVV be reentered each time a purchase is made. In this case the behavioral profile of the merchant can inform the analysis that CVV is not a positive or negative indicator of card of file for a particular merchant.

Similar analysis can be done for any data element or factor to improve the accuracy of the credential on file score.

An embodiment of the present disclosure can provide A system for predicting on-file payment credentials, the system comprising: a processor; a memory storing instructions that, when executed by the processor, cause the system to: obtain, from a financial institution, transaction data comprising one or more transactions conducted at one or more merchants; for each respective merchant of the one or more merchants, parse each of the one or more transactions at the respective merchant to create a merchant profile for the respective merchant, the merchant profile comprising merchant behavior data for the respective merchant; receive, from a customer, a card-on-file request comprising payment credential information relating to a payment credential; generate a purchase report, the purchase report identifying purchases conducted by the customer using the payment credential, each purchase in the purchase report having an associated merchant; determine, for each respective associated merchant in the purchase report, a likelihood of a respective associated merchant in the purchase report having the payment credential information on file by calculating a score for the respective associated merchant based on the respective associated merchant's merchant profile, the score representing that behavior represented in the respective associated merchant's merchant profile is indicative of the respective associated merchant having the payment credential information stored on file; generate a list of merchants from the purchase report each having a score above a predetermined threshold.

In any of the embodiments disclosed herein, each of the one or more transactions can comprise a merchant identifier, an end brand, a facilitator brand, and a wallet brand.

In any of the embodiments disclosed herein, the instructions further can cause the system to: determine a credential on file brand, wherein the credential on file brand is selected from one of: the end brand, the facilitator brand, or the wallet brand; and associate the credential on file brand with the merchant profile.

In any of the embodiments disclosed herein, the instructions can further cause the system to, during the parsing of the one or more transactions: select a first merchant from the one or more merchants; determine a first purchase of the one or more purchases wherein the first merchant is the credential on file brand; analyze a behavior of the first merchant to determine how the first merchant handles the first purchase compared to subsequent purchases when the first merchant is the credential on file brand; and store the behavior of the first merchant in the merchant profile.

In any of the embodiments disclosed herein, the selecting a merchant from the one or more merchants, determining the first purchase, analyzing the behavior, and storing the behavior described above can be iteratively performed for all of the one or more merchants, such as a second merchant, a third merchant, a fourth merchant, and the like.

These and other aspects of the present invention are described in the Detailed Description of the Invention below and the accompanying figures. Other aspects and features of examples of the present invention will become apparent to those of ordinary skill in the art upon reviewing the following description of specific examples of the present invention in concert with the figures. While features of the present invention may be discussed relative to certain examples and figures, all examples of the present invention can include one or more of the features discussed herein. Further, while one or more examples may be discussed as having certain advantageous features, one or more of such features may also be used with the various examples of the invention discussed herein. In similar fashion, while examples may be discussed below as device, system, or method examples, it is to be understood that such examples can be implemented in various devices, systems, and methods of the present invention.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 is a diagram illustrating an environment in which a system operates in accordance with the present disclosure.

FIG. 2 is a block diagram illustrating the data structure of a Card on File List in accordance with the present disclosure.

FIG. 3 is a block diagram illustrating the data structure of an Enhanced Transaction in accordance with the present disclosure.

FIG. 4 is a flow chart illustrating the creation of a Merchant Profile in accordance with the present disclosure.

FIG. 5 is a flowchart illustrating the creation of a Card on File Score in accordance with the present disclosure.

FIG. 6 is a flowchart illustrating a method in accordance with the present disclosure.

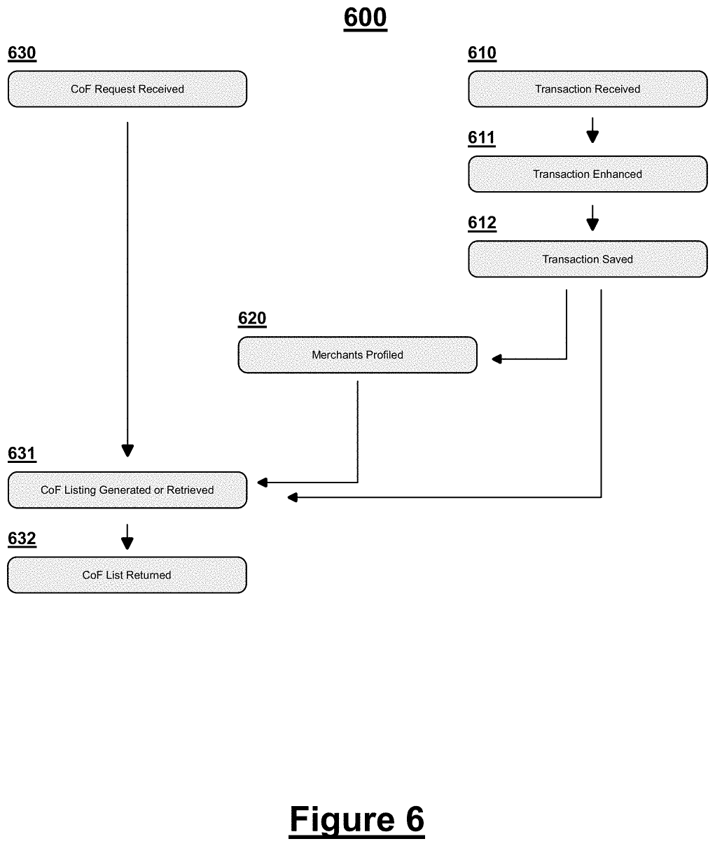

### DETAILED DESCRIPTION

As described above, when consumers purchase goods and services from merchants through digital channels such as websites and mobile apps, they often have an account with that merchant. Merchants can choose to store the consumer's credit card, debit card, or other payment credential with the merchant to make future purchases easier or in some cases to automatically pay for a recurring service. During the lifetime of a payment credential a user may lose track of what merchants have stored their payment credential on file.

It is often difficult for current online systems to monitor and track merchants where payment credentials are stored on file. Transactions made by credit cards, for example, show up on statements with little more than a cryptic merchant identifier and a transaction amount. Furthermore, the rise of money transfer services (e.g., Paypal, Venmo, Square, etc.) complicate the transactions. Not only do these money transfer services store data and track transactions differently, but users can also utilize these services and “middlemen” for transactions. As such, any system monitoring payment credentials must necessarily track and decrypt the abundance of transaction data which comes in many different forms. These acts consume large amounts of data storage and processing power, and the dissimilar transaction data can cause software and programming interfaces to throw errors. The disclosed systems and methods are able to take in the variety of transactional data, enhance the transactions, and determine merchant behavior. Using such factors (as well as those other factors disclosed herein), the present systems and methods can determine which services have stored payment credentials on file.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

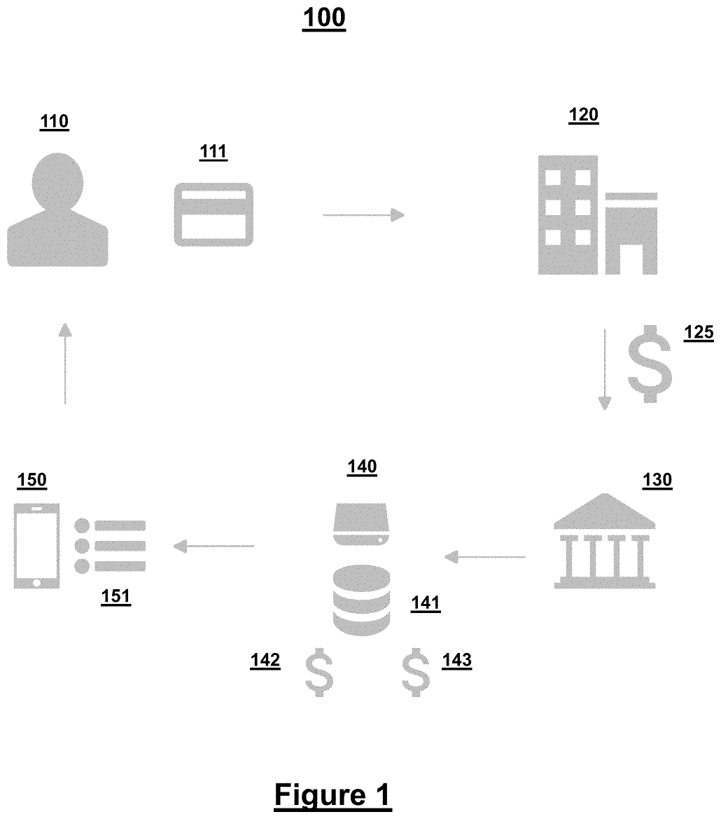

FIG. 1 illustrates a possible environment through which a system 100 may operate, consistent with embodiments of the present disclosure. A card holder 110 possesses a payment instrument 111. Payment instrument 111 is used to make a purchase with business 120. The environment may include a user device, a merchant point of sale (hereinafter “POS”) terminal, a merchant database terminal, a third-party server, a network 106, and an organization in communication with the business 120 including, for example, a web server, a location services server, a transaction server, a local network, a budget management device, and a database 118.

Business 120 can process the purchase as a transaction 125 with cardholder's bank 130. Bank 130 can provide transaction data to Card on File (CoF) Service 140 which can store a subset of data from transaction 125 as transaction data 142 in database 141. CoF Service 140 can also create and store enhanced transaction data 143 along with the transaction details 142. Using transaction data 142 and data 143 stored in database 141, CoF Service 140 may provide a Card on File List 151 to be displayed through digital or analog channels 150, such as mobile phones, tablets, personal computers, or printing on paper. The digital and/or analog channels 150 can include a graphical user interface (GUI) which can display the Card on File List 151.

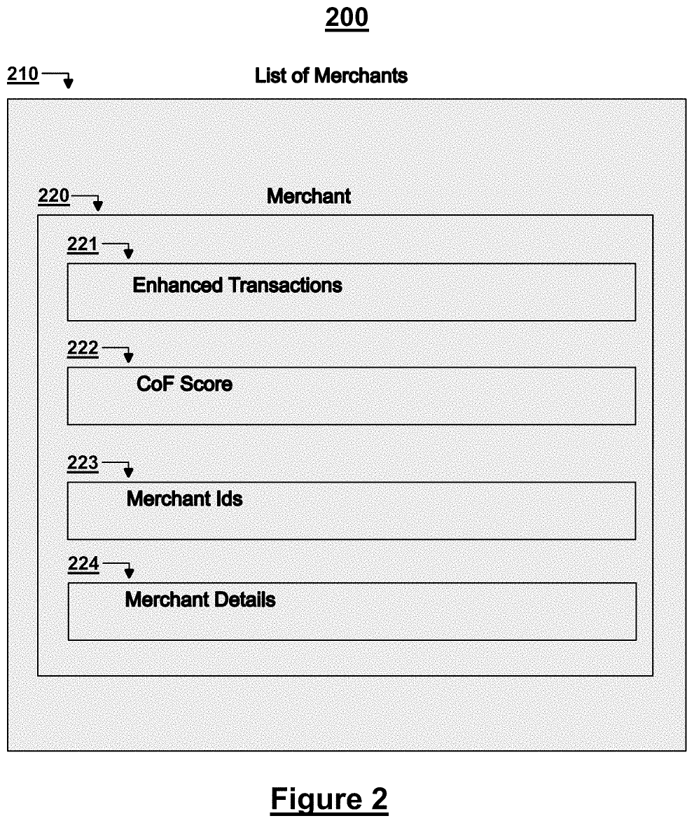

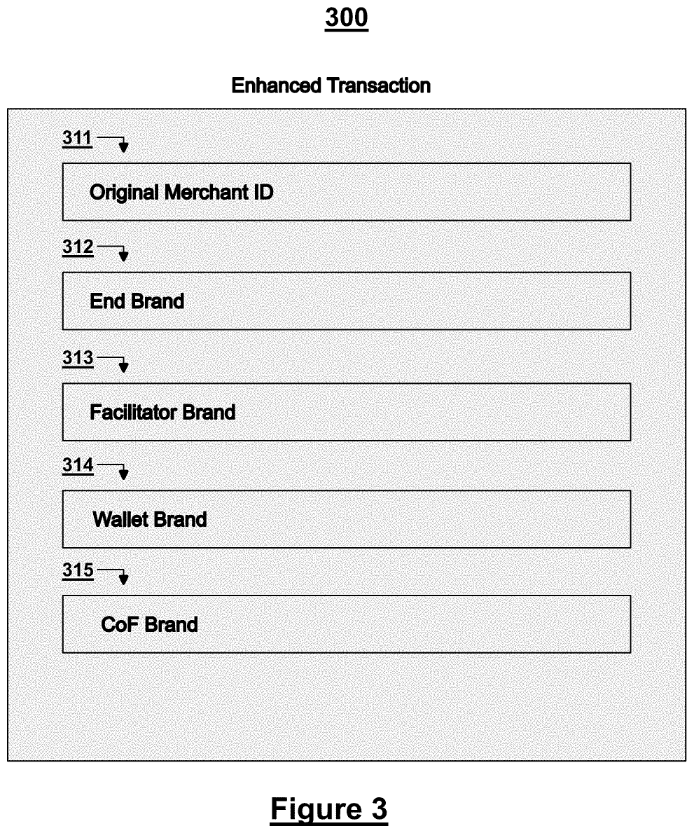

FIG. 2 illustrates a block diagram of Card on File list 200. The Card on File list 200 can be presented in a GUI, in a spreadsheet, an ordered list, a web diagram, and the like. A card on file list 200 includes a list of merchants 210. Each merchant 220 in list of merchants 210 may contain, but is not limited to: a list of enhanced transactions 221 for merchant 220, further described in FIG. 3; a score 222 determining the likelihood that merchant 220 has saved the present card on file; a list of merchant IDs 223 used by merchant 220 in the transactions 221; additional details 224 about merchant 220 including but not limited to its website URL, contact phone number, brand names, and logos.

Merchant IDs 223 can include the unique merchant identifier provided by the merchant 220, a merchant acquirer, or a payment network. The unique merchant identifier can comprise a set of characters (e.g., numbers or letters). The set of characters can help a user identify the actual business. This can include a business name, a partial business name, part of an address, a whole address, a phone number, or website. The merchant identifier can also be 40 characters or less.

As described above, because there is no way to guarantee the knowledge of whether a card is on file or not, a confidence score 222 can be generated through the analysis of merchant 220 behavior and payment behavior of the payment credentials with the merchant 220. Financial transactions 221 may contain multiple data elements that may be analyzed to help identify if a merchant 220 has a credential stored on file. This includes, but is not limited to the date, time, amount, merchant category code, usage of card verification value (CVV/CVV2) or similar field, and PAN entry mode. In addition to data elements, derived factors from modifying or combining data elements or other analysis of the purchases or merchants can also be used to determine the likelihood score that a merchant is storing a credential on file, hereafter referred to as credential on file score.

As an example, a consumer may make a first-time purchase with a merchant 220, in which case a CVV may be present. The consumer may return to the merchant 220 and use the same account with a card stored on file. In this case, the CVV might not be present because the system already knows the CVV associated with the consumer. By analyzing these two examples of a purchase 221 from a payment credential to a merchant 220, the system can increase the confidence score that a merchant 220 has a payment credential stored on file. However, some merchants 220 may request that the CVV be reentered each time a purchase is made. In this case, the behavioral profile of the merchant 220 can inform the analysis that the CVV is not a positive or a negative indicator of card of file for a particular merchant.

FIG. 3 illustrates the enhanced transaction 300. A nonlimiting example of an enhanced transaction 300 simply to provide context is as follows: a cardholder purchases a meal at Chipotle, but does so using the Doordash app, while paying with Google Pay. In this case, Chipotle would be end brand 312, Doordash would be the facilitator brand 313, and Google Pay would be the Wallet brand 314. Google pay would then be listed for the card on file brand 315.

The enhanced transaction 300, also represented in FIG. 1 as 143, adds additional data to the transaction data 142 and may contain, but is not limited to: the original merchant ID (e.g., the merchant ID of the merchant making the transaction) and/or or a subset of the characters present in transaction 125 (e.g., the merchant ID of the facilitator brand 313 and/or the end brand 312 present in the transaction); the end brand 312 (i.e., the entity to which the funds associated with the transaction will ultimately go); the facilitator brand 313 (i.e., a third-party entity that is not the end brand 312 nor the card holder that can transfer funds from the card holder to the end brand 312) of the transaction if a one was used for the present transaction; the wallet brand 314 (i.e., another third party entity that is not the end brand 312 nor the card holder that can retain payment information of the card holder to transfer said information to the end brand 312) of the transaction if one was used for the present transaction; and the brand between the end brand, the facilitator brand, or the wallet brand which stores the payment credentials 111 that was used to process transaction 125.

The additional data added to the transaction data 141 can be obtained from a database internal to the Card on File Service 140 (e.g., data 143 stored in database 141). The only data the system has initially is the transaction data 141 which is provided as a part of the transaction. In such a manner, the transaction data 141 can provide clues that allow the Card on File Service 140 to then add in additional details and enhanced data from the database 141.

Payment facilitator 313 may act in place of merchant 120 to process transactions 125 with bank 130, in doing so sending funds to the business providing the product or service that is being paid for 312 through transaction 125. In these cases, the end brand 312 would be different from the facilitator brand 313. In one such example, a customer can set up an account with PayPal. In doing so, the customer can be using Paypal to complete a purchase at the end merchant, such as Ebay. PayPal can then pay Ebay, the end brand 312. In such an example, the end brand 312 will be Ebay, but the facilitator brand will not be Paypal. Rather, the transaction will be between Paypal and Ebay with Paypal being the customer and Ebay being the end brand 312.

Wallets such as, but not limited to, Google Pay, PayPal, or Apple pay may be used as the payment instrument which would then give the transaction a wallet brand 314. As would be understood, the wallet brand 314 can be entities who are authorized to maintain and/or store virtual payment credentials in a digital wallet. The wallet brand 314 can also include any entities who are authorized to maintain and/or store financial information such as bank information. Suitable examples can include, but are not limited to, Venmo, Zelle, Squarecash, CashApp, and the like. Cases exist where an end brand 312, facilitator brand 313, and wallet brand 314 may all be present (e.g., the example in FIG. 3), in which case brand 315 informs which of those brands has payment credentials 111. In such an example, the system can analyze the behavior of each of the end brand 312, facilitator brand 313, and wallet brand 314 to assign to each a confidence score indicative of which brand 315 is the card on file brand, as described above.

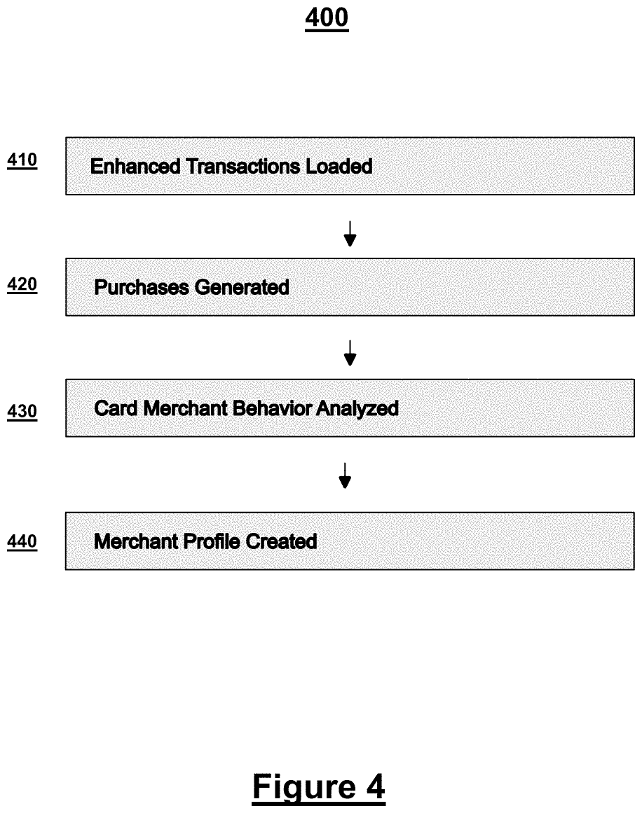

FIG. 4 illustrates an example process 400 for creating a merchant profile 440, according to certain embodiments. System 140 may create all enhanced transactions or a subset of enhanced transaction 410. As described above, system 140 can receive the transaction data 142 from the transactions 125 made at merchants 220. In some examples, the transaction data 142 can be requested from each of the merchants 220. In other examples, the merchants 220 can routinely transmit the transaction data 142 to the system 140 at predetermined intervals. The predetermined intervals can be determined in an agreement between the system 140 and each merchant 220. In other examples still, the merchants 220 can send the transaction data 142 to the system 140 in bulk, and the system 140 can store the transaction data. In such a manner, the system 140 can retrieve the transaction data 142 from a database or other storage device before creating the enhanced transactions 410. For each enhanced transaction 410, system 140 can then group those transactions into purchases 420.

The enhanced transaction 300, also represented in FIG. 1 as 143, adds additional data to the transaction data 142 and may contain, but is not limited to: the original merchant ID (e.g., the merchant ID of the merchant making the transaction) and/or or a subset of the characters present in transaction 125 (e.g., the merchant ID of the facilitator brand 313 and/or the end brand 312 present in the transaction); the end brand 312 (i.e., the entity to which the funds associated with the transaction will ultimately go); the facilitator brand 313 (i.e., a third-party entity that is not the end brand 312 nor the card holder that can transfer funds from the card holder to the end brand 312) of the transaction if a one was used for the present transaction; the wallet brand 314 (i.e., another third party entity that is not the end brand 312 nor the card holder that can retain payment information of the card holder to transfer said information to the end brand 312) of the transaction if one was used for the present transaction; and the brand between the end brand, the facilitator brand, or the wallet brand which stores the payment credentials 111 that was used to process transaction 125.

The additional data added to the transaction data 141 can be obtained from a database internal to the Card on File Service 140 (e.g., data 143 stored in database 141). The only data the system has initially is the transaction data 141 which is provided as a part of the transaction. In such a manner, the transaction data 141 can provide clues that allow the Card on File Service 140 to then add in additional details and enhanced data from the database 141.

One or many enhanced transactions 410 may make up a single purchase 420. For example, a customer may have one transaction with merchant 220 upon purchasing a product from an online store. If the customer pays for the product using PayPal, for instance, one enhanced transaction can be the customer purchasing the item and giving the PayPal information (e.g., the wallet brand information) to the merchant. A second enhanced transaction can occur when the merchant 220 requests the funds from the customer's PayPal, occurring without the involvement of the customer. Further still, a third enhanced transaction can occur when the purchased product ships from the merchant 220 to the customer. The merchant 220 can send a notification indicating the same directly to the customer, this time bypassing the wallet brand (e.g., PayPal). Another example of this would be if a merchant sends one transaction 125 to merchant 130 at the time a cardholder 110 purchased a good and a second transaction 125 when the good was shipped by merchant 130.

Purchases 420 can then be summarized into a Card Merchant Behavior 430 record when one or more purchases can make up a single Card Merchant Behavior 430. The purchases 420 can include transaction data 141, a merchant ID, an identifier of the card holder 110, and other data 143 related to each of the transactions 125. The purchases 420 can also include purchase information, such as card holder 110 information, a receipt, a transaction amount, discounts, coupons, transaction date, time, or location, or merchant location. Financial transactions may contain multiple data elements that may be analyzed to help identify if a merchant has a credential stored on file. This includes, but is not limited to the date, time, amount, merchant category code, usage of card verification value (CVV/CVV2) or similar field, and PAN entry mode.

Multiple Card Merchant Behavior 430 records data for a single merchant, but multiple cards can be analyzed to determine merchant behavior including patterns of transaction 125, use of data, and data elements used in transactions 125, thus resulting in a single Merchant Profile 440. The Card Merchant Behavior 430 can include information regarding how each merchant handles data from the card holder 110. Specifically, the system 100 can analyze the merchant behavior to determine patterns when the merchant is the Card on File brand 315. For example, the Card Merchant Behavior can include an indicator to indicate whether or not each merchant stores a card verification value (CVV) for each card holder. This can indicate to the system 100 that the merchant is the CoF brand 315 in these transactions. If any transactions do not have a stored CVV, then that can indicate to the system 100 that the CoF brand 315 is not the merchant and is a different brand (such as a wallet brand 314 and/or a facilitator brand 313). In such a manner, the system 100 can create a Merchant Profile 440 for each merchant.

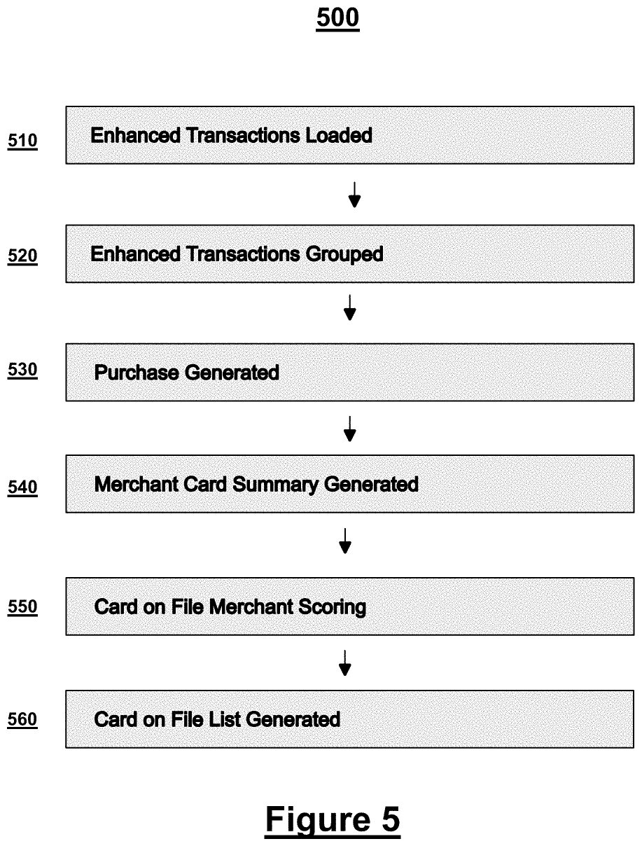

The Merchant Profile 440 can store the behavior of the merchant when the merchant is the CoF brand 315. The merchant profile 440 can be created to determine how the merchant uses data elements when consumers make purchases for the first time using the payment credential and when they make subsequent purchases with the same payment credential. Purchases can be identified as either a single financial transaction of $0 or more, or groups of financial transactions. Purchase behavior can also be profiled between purchases where the consumer has an account and when they do not have an account with the merchant. This information can be combined with the behavior of the first purchase with a payment credential compared to subsequent purchases with a payment credential. In other words, the Merchant Profile 440 can keep track of how the merchant 220 interacts with card holders 110 who store their card information with said merchant. The Merchant Profile 440 can be later used in FIG. 5 to prevent false positives or false negatives in the generation of an accurate Card on File list.

While FIG. 5 is described with respect to system 140, it is understood that the method described in FIG. 5 can be implemented by other components, general purpose computers, processors, computing devices, and the like. FIG. 5 illustrates the flow 500 for creating a Card on File List 550, also referenced as 151 and 632. Any state of the process may be saved and retrieved, and the process continued at a later time.

First, system 140 can retrieve 510 a list of Enhanced Transactions and then group 520 those transactions by Card of File Brand. As described above, the grouped enhanced transactions can be further grouped 530 and summarized 535 into purchases, where a purchase can be made up of one or more transactions. The system 140 can then generate 540 a merchant card summary by analyzing and summarizing the purchases for a Card on File Brand, generating a single merchant card summary for one or more purchases. The merchant card summary can include a merchant ID and/or merchant behavior for the one or more purchases. By using the merchant card summary generated in step 540, the system 140 can create 550 a score, determining the likelihood that the Card on File Brand has stored the cardholder's payment credentials on file. By repeating steps 530 through 550 for each brand grouping from step 520, the system 140 can generate 560 a card on file list. The system can then provide the card on file list to the customer, outlining the likelihood that each merchant has the customer's card on file.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

What is claimed is:

1. A system for predicting on-file payment credentials, the system comprising:
a processor;
a memory storing instructions that, when executed by the processor, cause the system to:
obtain, from a financial institution, transaction data comprising one or more transactions conducted at one or more merchants;
for each respective merchant of the one or more merchants, parse each of the one or more transactions at the respective merchant to create a merchant profile for the respective merchant, the merchant profile comprising merchant behavior data for the respective merchant;
receive, from a customer, a card-on-file request comprising payment credential information relating to a payment credential;
generate a purchase report, the purchase report identifying purchases conducted by the customer using the payment credential, each purchase in the purchase report having an associated merchant;
determine, for each respective associated merchant in the purchase report, a likelihood of a respective associated merchant in the purchase report having the payment credential information on file by calculating a score for the respective associated merchant based on the respective associated merchant's merchant profile, the score representing that behavior represented in the respective associated merchant's merchant profile is indicative of the respective associated merchant having the payment credential information stored on file; and
generate a list of merchants from the purchase report each having a score above a predetermined threshold.

2. The system of claim 1, wherein each of the one or more transactions comprises a merchant identifier, an end brand, a facilitator brand, and a wallet brand.

3. The system of claim 2, wherein the instructions further cause the system to:
determine a credential on file brand, wherein the credential on file brand is selected from one of: the end brand, the facilitator brand, or the wallet brand; and
associate the credential on file brand with the merchant profile.

4. The system of claim 3, wherein the instructions further cause the system to, during the parsing of the one or more transactions:
select a first merchant from the one or more merchants;
determine a first purchase of the one or more purchases wherein the first merchant is the credential on file brand;
analyze a behavior of the first merchant to determine how the first merchant handles the first purchase compared to subsequent purchases when the first merchant is the credential on file brand; and
store the behavior of the first merchant in the merchant profile.

5. The system of claim 1, wherein purchase report wither comprises one or more enhanced transactions, the one or more enhanced transactions comprising the transaction data and merchant data related to each respective merchant.

6. The system of claim 1, wherein the merchant data comprises a merchant identifier.

7. The system of claim 1, further comprising a graphical user interface (GUI) configured to display the list of merchants and the score.

8. The system of claim 7, where in the GUI is further configured to display the credential on file brand.

9. A method for predicting on-file payment credentials, the method comprising:
obtaining, from a financial institution, transaction data comprising one or more transactions conducted at one or more merchants;
for each respective merchant of the one or more merchants, parsing each of the one or more transactions at the respective merchant to create a merchant profile for the respective merchant, the merchant profile comprising merchant behavior data for the respective merchant;
receiving, from a customer, a card-on-file request comprising payment credential information relating to a payment credential;
generating a purchase report, the purchase report identifying purchases conducted by the customer using the payment credential, each purchase in the purchase report having an associated merchant;
determining, for each respective associated merchant in the purchase report, a likelihood of a respective associated merchant in the purchase report having the payment credential information on file by calculating a score for the respective associated merchant based on the respective associated merchant's merchant profile, the score representing that behavior represented in the respective associated merchant's merchant profile is indicative of the respective associated merchant having the payment credential information stored on file; and
generating a list of merchants from the purchase report each having a score above a predetermined threshold.

10. The method of claim 9, wherein each of the one or more transactions comprises a merchant identifier, an end brand, a facilitator brand, and a wallet brand.

11. The method of claim 10, further comprising:
determining a credential on file brand, wherein the credential on file brand is selected from one of: the end brand, the facilitator brand, or the wallet brand; and
associating the credential on file brand with the merchant profile.

12. The method of claim 11, further comprising, during the parsing of the one or more transactions:
selecting a first merchant from the one or more merchants;
determining a first purchase of the one or more purchases wherein the first merchant is the credential on file brand;
analyzing a behavior of the first merchant to determine how the first merchant handles the first purchase compared to subsequent purchases when the first merchant is the credential on file brand; and
storing the behavior of the first merchant in the merchant profile.

13. The method of claim 9, wherein purchase report wither comprises one or more enhanced transactions, the one or more enhanced transactions comprising the transaction data and merchant data related to each respective merchant.

14. The method of claim 9, wherein the merchant data comprises a merchant identifier.

15. The method of claim 9, further comprising a graphical user interface (GUI) configured to display the list of merchants and the score.

16. The method of claim 9, where in the GUI is further configured to display the credential on file brand.

17. A method for predicting on-file payment credentials, the method comprising:
obtaining, from a financial institution, transaction data comprising one or more transactions conducted at one or more merchants, wherein each of the one or more transactions comprises a merchant identifier, an end brand, a facilitator brand, and a wallet brand;
for each respective merchant of the one or more merchants, parsing each of the one or more transactions at the respective merchant to create a merchant profile for the respective merchant, the merchant profile comprising merchant behavior data for the respective merchant;
receiving, from a customer, a card-on-file request comprising payment credential information relating to a payment credential;
determining a credential on file brand, wherein the credential on file brand is selected from one of: the end brand, the facilitator brand, or the wallet brand; and
associating the credential on file brand with the merchant profile.

18. The method of claim 17, further comprising, during the parsing of the one or more transactions:
select a first merchant from the one or more merchants;
determine a first purchase of the one or more purchases wherein the first merchant is the credential on file brand;
analyze a behavior of the first merchant to determine how the first merchant handles the first purchase compared to subsequent purchases when the first merchant is the credential on file brand; and
store the behavior of the first merchant in the merchant profile.

19. The method of claim 17, further comprising:
generating a purchase report, the purchase report identifying purchases conducted by the customer using the payment credential, each purchase in the purchase report having an associated merchant;
determining, for each respective associated merchant in the purchase report, a likelihood of a respective associated merchant in the purchase report having the payment credential information on file by calculating a score for the respective associated merchant based on the respective associated merchant's merchant profile, the score representing that behavior represented in the respective associated merchant's merchant profile is indicative of the respective associated merchant having the payment credential information stored on file; and
generating a list of merchants from the purchase report each having a score above a predetermined threshold.

20. The method of claim 19, wherein purchase report wither comprises one or more enhanced transactions, the one or more enhanced transactions comprising the transaction data and merchant data related to each respective merchant.
